(19) United States
(12) Patent Application Publication
(10) Pub. No.: US 2019/0139499 A1
(43) Pub. Date: May 9, 2019

(54) POWER CONTROL METHOD AND POWER CONTROL DEVICE FOR BACKLIGHT SOURCE OF DISPLAY DEVICE

(71) Applicant: MStar Semiconductor, Inc., Hsinchu Hsien (TW)

(72) Inventor: HUI WU, Shenzhen (CN)

(21) Appl. No.: 16/115,708

(22) Filed: Aug. 29, 2018

(30) Foreign Application Priority Data
Sep. 29, 2017 (CN) 201710916924.X

(51) Int. Cl. G09G 3/34; G02F 1/1335

(52) U.S. Cl. CPC G09G 3/3426; G09G 3/3413; G09G 2320/064; G09G 2330/021; G02F 1/133602

(57) ABSTRACT

A power control method and a control device for a backlight source of a display device are provided. The backlight source includes multiple backlight lamps arranged in an array and respectively corresponding to different display regions of the display device. The method includes: acquiring an input power value corresponding to each of the backlight lamps according to video data; adjusting the input power value of each of the backlight lamps to acquire an output power value of each of the backlight lamps, wherein an adjustment magnitude in the output power value acquired from the backlight lamp having a higher input power value is greater than that from the backlight lamp having a lower input power value; and driving each of the backlight lamps according to the corresponding output power value thereof. The present invention enhances the contrast of the display device without burning the backlight lamps and the backlight source and changing hardware costs.

This application claims the benefit of China application Serial No. 201710916924.X, filed Sep. 29, 2017, the subject matter of which is incorporated herein by reference.

### BACKGROUND OF THE INVENTION

### Field of the Invention

The invention relates to the technical field of display, and more particularly to a power control method and device for a backlight source of a display device.

### Description of the Related Art

With the development of technologies, display devices with an image display function have become indispensable tools for work and life of people. Meanwhile, people continue to demand higher display qualities to meet work and life requirements.

Enhancing the contrast of video and image frames of a display device can enhance the display quality of a display device to a certain extent. The Applicant of the present invention has discovered on the basis of long-term development and research that, contrast enhancement is frequently achieved by increasing the power of a backlight lamp or a power board in the prior art. However, the above method causes an increase in hardware costs. Further, the prior art is incapable of effectively avoiding the power of a backlight lamp or a power board from exceeding a rated power of one single backlight lamp in a display region or a total rated power of all backlight lamps, thus resulting a potential risk of burning the backlight lamps or the power board by such increase in the power of backlight lamps.

### SUMMARY OF THE INVENTION

It is an object of the present invention to provide a power control method and a power control device for a backlight source of a display device. The power control method and the power control device of the present invention are capable of enhancing the contrast of a display device without burning a backlight lamp or a backlight source and increasing hardware costs.

To achieve the above object, the present invention provides a power control method for a backlight source of a display device. The backlight source includes multiple backlight lamps arranged in an array and respectively corresponding to different display regions of the display device. The power control method includes: acquiring an input power value corresponding to each of the backlight lamps according to video data; adjusting the input power of each of the backlight lamps to acquire an output power value of each of the backlight lamps, wherein an adjustment magnitude in the output power value acquired from the backlight lamp having a higher input power value is greater than an adjustment magnitude in the output power acquired from the backlight lamp having a lower input power value, the output power value of each of the backlight lamps is not greater than a rated power value of the backlight lamp, and a total output power value of the multiple backlight lamps is not greater than a rated power value of the backlight source; and driving each of the backlight lamps according to the corresponding output power value of each of the backlight lamps to enhance the contrast of the display device.

To achieve the above object, the present invention provides a power control device for a backlight source of a display device. The backlight source includes multiple backlight lamps arranged in an array and respectively corresponding to different display regions of the display device. The power control device includes: a processor, electrically connected to a main chip of the display device to acquire an input power value that the main chip allocates to each of the backlight lamps according to video data, and further adjusting the received input power value of each of the backlight lamps to generate an output power value of each of the backlight lamps, wherein an adjustment magnitude in the output power value acquired from the backlight lamp having a higher input power value is greater than an adjustment magnitude in the output power acquired from the backlight lamp having a lower input power value, the output power value of each of the backlight lamps is not greater than a rated power value of the backlight lamp, and a total output power value of the multiple backlight lamps is not greater than a rated power value of the backlight source; a current controller, electrically connected to the processor to receive the output power value, of each of the backlight lamps, adjusted by the processor, generating a current control signal corresponding to each of the backlight lamps according to the output power value of each of the backlight lamps; and a voltage converter, electrically connected to the current controller and the backlight lamps, outputting an output current corresponding to each of the backlight lamps according to the current control signal corresponding to each of the backlight lamps.

The present invention provides following effects compared to the prior art. In the present invention, the input power value of the backlight source of the display device is adjusted, such that the adjustment magnitude in the output power value acquired from the backlight lamp having a higher input power value is greater than the output power value acquired from the backlight lamp having a lower input power value, thus increasing the backlight brightness value of the display device for different display regions in a region-division manner and hence enhancing the contrast of the display device. Meanwhile, the output power value of each of the backlight lamps is not greater than the rated power value thereof, and the total output power value of the multiple backlight lamps is not greater than the rated power value of the backlight source. As such, when the input power values of the backlight lamps of the display are adjusted, an issue of burning the backlight lamps or backlight source by overly high output power values of the backlight lamps is avoided, while the rated power of the backlight source is not increased to further ensure that hardware costs are kept the same.

### BRIEF DESCRIPTION OF THE DRAWINGS

FIG. 1 is a flowchart of a power control method for a backlight source of a display device according to an embodiment of the present invention;

FIG. 2 is a flowchart of step S12 in a power control method for a backlight source of a display device according to an embodiment of the present invention;

FIG. 3 is a flowchart of step S121 in FIG. 2;

FIG. 4 is a flowchart of step S122 in FIG. 2;

FIG. 5 is a schematic diagram a predetermined power gain factor curve in a power control method for a backlight source of a display device according to an embodiment of the present invention;

FIG. 6 is a flowchart of step S123 in FIG. 2;

FIG. 7 is a block diagram of a power control device for a backlight source of a display device according to an embodiment of the present invention;

FIG. 8 is a block diagram of a processor 11 of a power control device for a backlight source of a display device according to an embodiment of the present invention;

FIG. 9 is block diagram of a rated power factor acquiring unit 111 in FIG. 8;

FIG. 10 is a block diagram of a total power gain factor acquiring unit 112 in FIG. 8;

FIG. 11 is a block diagram of an output power value acquiring unit 113 in FIG. 8;

FIG. 12 is another block diagram of a rated power factor acquiring unit 111 in FIG. 8; and

FIG. 13 is another block diagram of an output power value acquiring unit 113 in FIG. 8.

### DETAILED DESCRIPTION OF THE INVENTION

Specific details of the present invention are given in the description below to thoroughly understand the present invention. However, the present invention can be implemented by other methods different from those described below, and a person skilled in the art can make similar arrangements on the basis of the disclosure below without departing from the spirit of the present invention. That is, the present invention is not limited to the disclosure of the embodiments below.

In view of the issues of the prior art, the present invention provides a power control method and a power control device for a backlight source of a display device. Details of the present invention are given in the embodiments with the accompanying drawings below.

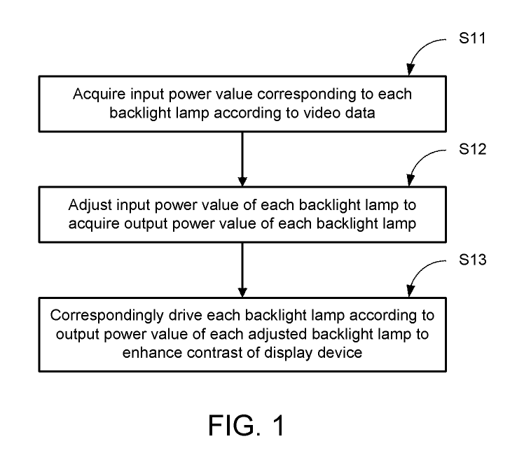

FIG. 1 shows a flowchart of a power control method for a backlight source of a display device according to an embodiment of the present invention.

In this embodiment, the backlight source of the display device includes multiple backlight lamps, which are arranged in an array and respectively correspond to different display regions of the display device. The power control method of this embodiment includes the following steps.

In step S11, an input power value corresponding to each of the backlight lamps is acquired according to video data.

In step S12, the input power value of each of the backlight lamps is adjusted to acquire an output power of each of the backlight lamps.

In step S13, each of the backlight lamps is driven according to the corresponding output power value of each of the backlight lamps to enhance the contrast of the display device.

Specifically, in the present invention, the video data is data information received from an external terminal or stored in a local device, and can be displayed by the display device.

The video data includes various types of data information corresponding to the video data. Thus, the display device can acquire brightness values needed by different display regions according to the various types of data information, and acquire an input power value Pin corresponding to each of the backlight lamps of the display device according to the brightness values needed by the different display regions. After the input power value corresponding to each of the backlight lamps is acquired, the power control method adjusts the input power value Pin corresponding to each of the backlight lamps according to a predetermined rule, so as to acquire an output power value Pout of each of the backlight lamps, and then drive each of the backlight lamps according to the acquired output power value Pout of each of the backlight lamps. That is to say, in the present invention, the output power value Pout of each of the backlight lamps is acquired from adjusting the input power value Pin of each of the backlight lamps and used for correspondingly driving each of the backlight lamps when the display device outputs the video data and displays a corresponding image.

Because a rated power value RP_{B} (i.e., a rated power inputted by a power board to the backlight source) of the backlight source of the display device is a certain value, the model numbers of the backlight lamps in the backlight source are usually the same (equivalent to that the properties of the backlight lamps are identical). Thus, a normal operating power limit value PL of each of the backlight lamps can be calculated according to the rated power value RP_{B} of the backlight source and the number N_{LED} of the backlight lamps in the backlight source; that is, the normal operating power limit value PL of each of the backlight lamps is equal to a ratio of the rated power value RP_{B} of the backlight source to the number N_{LED} of the backlight lamps in the backlight source, PL=RP_{B}/N_{LED}. The input power value Pin corresponding to each of the backlight lamps is usually not higher than the normal operating power limit value PL of the backlight lamp, and the normal operating power limit value PL of each of the backlight lamps is not higher than a rated power value RP_{L} of each of the backlight lamps. Thus, the input power value Pin corresponding to each of the backlight lamps can be adjusted, such that the output power value Pout is appropriately increased relative to the input power value Pin, so as to enhance the contrast of the display device for displaying the video data and further improve the display performance of the display device.

A person skilled in the art can understand that, the model numbers of the backlight lamps in the backlight source may be different. Thus, a product, of the ratio of the rated power value RP_{B} of the backlight source to the sum TRP_{L} of the rated power values of all of the backlight lamps and the rated power values RP_{L} of each of the backlight lamps, may serve as the normal operating power limit value PL of each of the backlight lamps, i.e., PL=(RP_{B}/TRP_{L})*RP_{L}. At this point, the normal operating power limit value P_{L} of each of the backlight lamps is not higher than the rated power value RP_{L} of each of the backlight lamps, and the input power value Pin of each of the backlight lamps is not higher than the normal operating power limit value PL of each of the backlight lamps. Hence, the input power value Pin corresponding to each of the backlight lamps may also be adjusted such that the output power value Pout of the backlight lamp is appropriately increased relative to the input power value Pin, thus enhancing the contrast of the display device for displaying the video data and improving the display effect of the display device.

In this embodiment, through a certain approach, an adjustment magnitude in the output power value Pout correspondingly acquired from the backlight lamp having a high input power value Pin is greater than an adjustment magnitude in the output power value Pout correspondingly acquired from the backlight lamp having a low input power value Pin. More specifically, by increasing the input power values Pin of all of the backlight lamps, the input power values Pin of the backlight lamps having high input power values Pin can be increased by larger adjustment magnitudes, and the input power values Pin of the backlight lamps having low input power values Pin can be increased by smaller adjustment magnitudes.

Further, during the adjustment, it is necessary to control the output power value Pout of each of the backlight lamps to be not greater than the rated power value RP_{L} thereof, and the total TPout of the output power values Pout of the multiple backlight lamps to be not greater than the rated power value RP_{B} of the backlight source. For example, the above can be implemented by adjusting the input power value Pin corresponding to each of the backlight lamps, or be realized according to other predetermined rules.

In this embodiment, the input power value Pin of the backlight source of the display device is adjusted, such that the adjustment magnitude in the output power value Pout acquired from the backlight lamp having a high input power value is greater than the output power value Pout acquired from the backlight lamp having a low input power value, thus increasing the backlight brightness value of the display device for different display regions in a region-division manner and hence enhancing the contrast of the display device. Meanwhile, the output power value Pout of each of the backlight lamps is not greater than the rated power value RP_{L} thereof, and the total output power value TPout of the multiple backlight lamps is not greater than the rated power value RP_{B} of the backlight source. As such, when the input power values Pin of the backlight lamps of the display device are adjusted, an issue of burning the backlight lamps or backlight source by an overly high total output power values TPout of the backlight lamps is avoided, while hardware costs are maintained the same without increasing the rated power value RP_{B} of the backlight source.

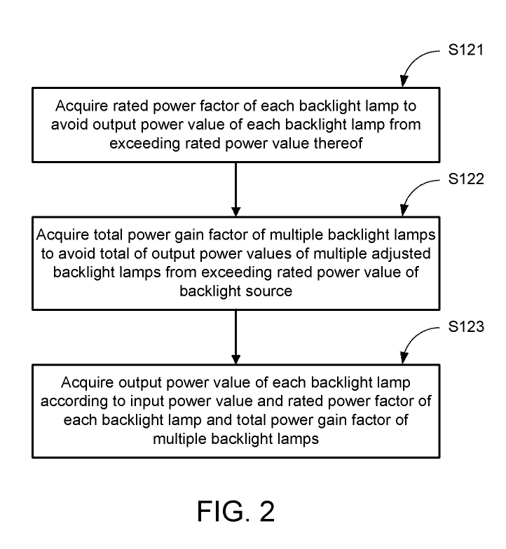

Referring to FIG. 2, step S12 in one embodiment includes steps S121, S122 and S123.

In step S121, the rated power factor of each of the backlight lamps is acquired to avoid the output power value Pout of each of the backlight lamps from exceeding the rated power value RP_{L} of the backlight lamp.

The rated power factor LBR (LED burst ratio) of each of the backlight lamps refers to a factor that limits the output power value Pout of each of the backlight lamps when the input power value Pin of the backlight lamp is adjusted to acquire the output power value Pout. The rated power factor LBR corresponds to the rated power value RP_{L} of the backlight lamps, the rated power values RP_{L} of the backlight lamps may be equal or different, and the corresponding rated power factors LBR may be equal or different as well.

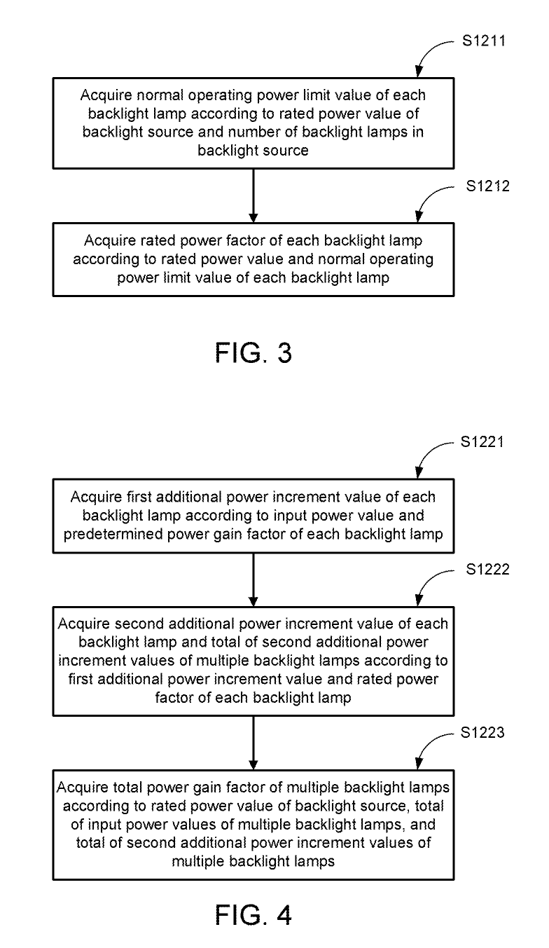

In one application scenario, referring to FIG. 3, the step of acquiring the rated power factor LBR of each of the backlight lamps includes step S1211 and step S1212.

In step S1211, the normal operating power limit value PL of each of the backlight lamps is acquired according to the rated power value RP_{B} of the backlight source and the number N_{LED} of the backlight lamps in the backlight source.

The rated power value RP_{B} of the backlight source is restricted by a power board. Thus, the rated power value of the power board is the rated power value RP_{B} of the backlight source. Further, the number of N_{LED} of the backlight lamps in the backlight source is also determined by the display device.

The normal operating power limit value PL of each of the backlight lamps is equal to the ratio of the rated power value RP_{B} of the backlight source to the number N_{LED} of the backlight lamps in the backlight source, i.e., PL=RP_{B}/N_{LED}.

In step S1212, the rated power factor LBR of each of the backlight lamps is acquired according to the rated power value RP_{L} and the normal operating power limit value PL of each of the backlight lamps.

The rated power value RP_{L} of each of the backlight lamps in the display device can be determined by the backlight lamp itself. More specifically, the rated power values RP_{L} of the backlight lamps may be equal or different, and the rated power factor LBR of each of the backlight lamps is determined jointly by the rated power value RP_{L} and the normal operating power limit value PL of the backlight lamp.

In this embodiment, the rated power factor LBR of each of the backlight lamps in the display device is the ratio of the rated power value RP_{L} to the normal operating power limit value PL subtracted by one, i.e., LBR=RP_{L}/PL−1. For example, when the rated power value RP_{B} of the backlight source is 160 W and the backlight source includes 20 backlight lamps, the normal operating power limit value PL of each of the backlight lamps is then RP_{B}/N_{LED}=160/20=8 W. If the rated power values RP_{L} of the backlight lamps are equal and are 12 W, the rated power factors LBR of the backlight lamps are also equal, and are RPL/PL−1=12 W/8 W−1=0.5.

In step S122, a total power gain factor TPLR (total power limit ratio) of the multiple backlight lamps is acquired, so as to avoid the total output power value TPout of the multiple backlight lamps from exceeding the rated power value RP_{B} of the backlight source.

The total power gain factor TPLR of the multiple backlight lamps refers to a factor for limiting the total output power value TPout of the multiple backlight lamps when the input power Pin of the backlight lamp is adjusted to acquire the output power value Pout. The total power gain factor TPLR of the multiple backlight lamps corresponds to the rated power value RP_{B} of the backlight source, and can usually be a constant value.

In one application scenario, referring to FIG. 4, the step of acquiring the total gain power factor TPLR of the multiple backlight lamps includes step S1221, step S1222 and step S1223.

In step S1221, a first additional power increment value A1 of each of the backlight lamps is acquired according to the input power value Pin and a predetermined power gain factor DR of each of the backlight lamps.

The predetermined power gain factor DR is configured in advance, and the input power value Pin of the backlight lamp is adjusted through the predetermined power gain factor DR to acquire the first additional power increment value A1, i.e., D1=DR*Pin. The predetermined power gain factor gain DR may be acquired according to the rule of thumb of a person skilled in the art, properties of the display device and the information included in the video data.

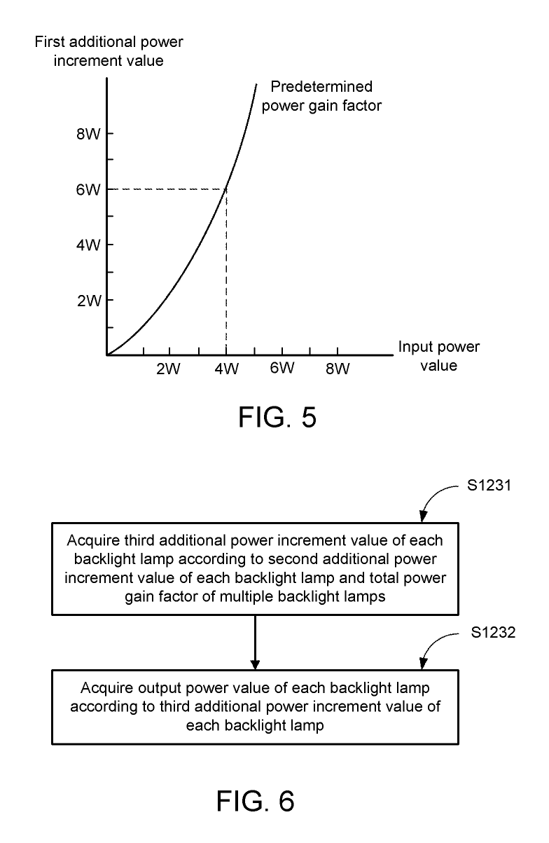

In one application scenario, referring to FIG. 5, a predetermined power gain factor curve can be configured, in which a slope of a tangent of a point in the curve corresponds to the predetermined power gain factor DR of the point, and the horizontal and vertical coordinates of the point respectively correspond to the input power value Pin of the backlight lamp and the first additional power increment value A1, wherein the first additional power increment value A1 of each of the backlight lamps can be directly acquired according to the input power value Pin and the predetermined power gain factor DR of each of the backlight lamps. For example, when the input power value Pin of the backlight lamp is 4 W, the first additional power increment value A1 of the backlight lamp corresponding to the predetermined power gain factor curve is 6 W.

In another application scenario, the input power value Pin, the predetermined gain factor Dr and the first additional power increment value A1 of the each of the backlight lamps may be represented in form of a table. Specifically, the first additional power increment value A1 may be looked up from the table after the input power value Pin of each of the backlight lamps is acquired.

In the present invention, to further enhance the contrast of the display device, when the power gain factor DR is configured in advance, the power gain factor DR for a higher input power value Pin may be set to a higher value and the power gain factor DR for a lower input power Pin may be set to a lower value. Thus, when the input power value Pin of each of the backlight lamps is adjusted to acquire the corresponding output power value Pout, the magnitude of increase in the output power value Pout of the backlight lamp having a higher input power value Pin is further increased, and conversely, the magnitude of increase in the output power value Pout of the backlight lamp having a lower input value Pin is further reduced, thus further enhancing the contrast of the display device.

A person skilled in the art can understand that, in the present invention, the power gain factor DR may also be set to a constant value, and the object of enhancing the contrast of the display device can nonetheless be achieved by using only the rated power factor LBR of each of the backlight lamps and the total power gain factor TPLR of the multiple backlight lamps.

In step S1222, a second additional power increment value A2 of each second backlight lamp and a total TA2 of the second additional power increment values A2 of the multiple backlight lamps are acquired according to the first additional power increment value A1 and the rated power factor LBR of each of the backlight lamps.

Specifically, the second additional power increment value A2 of each of the backlight lamps is equal to a product of the first additional power increment value A1 and the rated power factor LBR of each of the backlight lamps. It can be easily understood that, the total TA2 of the second additional power increment values A2 of the multiple backlight lamps is equal to the sum of the second additional power increments A2 of the backlight lamps.

In step S1223, the total power gain factor TPLR of the multiple backlight lamps is acquired according to the rated power value RP_{B} of the backlight source, the total TPin of the input power values Pin of the multiple backlight lamps, and the total TA2 of the second additional power increment values A2 of the multiple backlight lamps.

In this embodiment, the total power gain factor TPLR of the multiple backlight lamps is calculated as: subtracting the rated power value RP_{B} of the backlight source by the total TPin of the input power values Pin of the multiple backlight lamps to acquire a difference, and acquiring the ratio of the difference to the total TA2 of the second additional power increment values of the multiple backlight lamps, i.e., TPLR=(RP_{B}−TPin)/TA2. If the calculated total power gain factor TPLR is within [0, 1], the requirement is satisfied; if the calculated total power gain factor TPLR is greater than 1, the total power gain factor TPLR is corrected to 1.

Specifically, if the value of the total power gain factor TPLR calculated according to the above equation is within an interval of [0, 1], the total power gain factor TPLR satisfies the requirement and can be provided for subsequent calculations. For example, assume that the rated power value RP_{B} of the backlight source is 200 W, the total TPin of the input power values of the multiple backlight lamps is 80 W, and the total TA2 of the second additional power increment values of the multiple backlight lamps is 160 W. Because (200 W−80 W)/160 W=0.75ϵ[0, 1], the total power gain factor TPLR of the multiple backlight lamps is 0.75, and the value 0.75 is used as the value of the total power gain factor TPLR in subsequent calculations. In this application scenario, when the value of the above equation is within the interval [0, 1], determining the total power gain factor TPLR as the value acquired from the above equation is to avoid the total of the output power values Pout of the multiple backlight lamps in the backlight source from exceeding the rated power value RP_{B} of the backlight source, thus preventing the issue of burning the backlight source.

In another application scenario, if the value of the total power gain factor TPLR of the multiple backlight lamps calculated from the above equation is greater than 1, i.e., if (RP_{B}−TPin)/TA2>1, the total power gain factor TPLR of the multiple backlight lamps is designated as 1. For example, assume that the rated power value RP_{B} of the backlight source is 200 W, the total TPin of the input power values of the multiple backlight lamps is 80 W, and the total TA2 of the second additional power increment values of the multiple backlight lamps is 60 W. Then, (200 W−80)/20 W=2. At this point, because 2>1, the total power gain factor TPLR of the multiple backlight lamps is designated to be 1. In this application scenario, when the value of the above equation is greater than 1, determining the total power gain factor TPLR of the multiple backlight lamps to be 1 is to further avoid the output power value Pout of any of the backlight lamps from exceeding the rated power value RP_{L} of the backlight lamp, thus further preventing the issue of burning the backlight lamps. Associated details are explained below.

In conclusion, TPLR=minmax((RP_{B}−TPin)/TA2, 0, 1).

In step S123, the output power value Pout of each of the backlight lamps is acquired according to the input power value Pin and the rated power factor LBR of each of the backlight lamps as well as the total power gain factor TPLR of the multiple backlight lamps.

In this embodiment, the input power value Pin of each of the backlight lamps is first limited through the rated power factor LBR, and the total power gain factor TPLR of the multiple backlight lamps is further limited through the total TA2 of the second additional power increment values of the multiple backlight lamps, thus eventually acquiring the output power value Pout of each of the backlight lamps.

In an application scenario, referring to FIG. 6, the step of acquiring the output power value Pout of each of the backlight lamps includes step S1231 and step S1232.

In step S1231, a third additional power increment value A3 of each of the backlight lamps is acquired according to the second additional power increment value A2 of each of the backlight lamps and the total power gain factor TPLR of the multiple backlight lamps.

In step S1232, the output power value Pout of each of the backlight lamps is acquired according to the third additional power increment value A3 of each of the backlight lamps.

Specifically, the third additional power increment value A3 of each of the backlight lamps is equal to a product of the second additional power increment value A2 of each of the backlight lamps and the total power gain factor TPLR of the multiple backlight lamps, i.e., A3=A2*TPLR.

It should be noted that, in this embodiment, the rated power factor LBR of each of the backlight lamps is the ratio of the rated power value RP_{L} and the normal operating power limit value PL of each of the backlight lamps subtracted by 1, i.e., LBR=PLₘₐₓ/PL−1. At this point, the second additional power increment value A2 is a pure increment value acquired from adjusting the input power value Pin through the predetermined power gain factor DR and the rated power factor LBR of each of the backlight lamps. That is to say, the third additional power increment value A3 does not include the input power value Pin, and the input power value Pin needs to be further added in order to acquire the output power value Pout of the backlight lamp. That is, the output power value Pout of each of the backlight lamps is equal to the sum of the input power value Pin and the third additional power increment value A3 of each of the backlight lamps, i.e., Pout=A3+Pin.

For example, assume that the rated power value RP_{B} of the backlight source is 160 W, the number N_{LED} of the backlight lamps in the backlight source is 20, and the rated power values RP_{L} of the backlight lamps are all 12 W. Then, the acquired input power value Pin corresponding to each of the backlight lamps according to the video data is:

$$[ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ]$$

in a unit of W, and the predetermined power gain factor DR is 1. It is known from the above information that, the normal operating power limit values PL of the backlight lamps are all 8 W, and then the rated power factor LBR of each of the backlight lamps is 12/8 W−1=0.5. The first additional power increment value A1 of each of the backlight lamps is

$$[ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ] * 1 = [ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ] ,$$

and the corresponding second additional power increment value A2 of each of the backlight lamps is

$$[ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ] * 0.5 = [ \begin{matrix}0 & 0.5 & 0.5 & 0.5 & 4 \\ 0 & 0.5 & 0.5 & 0.5 & 0.5 \\ 0.5 & 0.5 & 0.5 & 0.5 & 0.5 \\ 0 & 0.5 & 0.5 & 0.5 & 0\end{matrix} ] ,$$

the total TA2 of the second additional power increment values of the multiple backlight lamps is: 0+0.5+0.5+0.5+4+0+0.5+0.5+0.5+0.5+0.5+0.5+0.5+0.5+0.5+0+0.5+0.5+0.5+0=11.5 W, and meanwhile, the total TPin of the input power values of the multiple backlight lamps is: 0+1+1+1+8+0+1+1+1+1+1+1+1+1+1+0+1+1+1+0=23 W. Then, the total power gain factor TPLR corresponds to (160 W−23 W)/11.5 W=11.913. Because 11.913>1, the total power gain factor TPLR of the multiple backlight lamps is 1. Thus, the third additional power increment value A3 of each of the backlight lamps is

$$[ \begin{matrix}0 & 0.5 & 0.5 & 0.5 & 4 \\ 0 & 0.5 & 0.5 & 0.5 & 0.5 \\ 0.5 & 0.5 & 0.5 & 0.5 & 0.5 \\ 0 & 0.5 & 0.5 & 0.5 & 0\end{matrix} ] * 1 = [ \begin{matrix}0 & 0.5 & 0.5 & 0.5 & 4 \\ 0 & 0.5 & 0.5 & 0.5 & 0.5 \\ 0.5 & 0.5 & 0.5 & 0.5 & 0.5 \\ 0 & 0.5 & 0.5 & 0.5 & 0\end{matrix} ] ,$$

and the output power value Pout corresponding to each of the backlight lamps is

$$[ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ] + [ \begin{matrix}0 & 0.5 & 0.5 & 0.5 & 4 \\ 0 & 0.5 & 0.5 & 0.5 & 0.5 \\ 0.5 & 0.5 & 0.5 & 0.5 & 0.5 \\ 0 & 0.5 & 0.5 & 0.5 & 0\end{matrix} ] = [ \begin{matrix}0 & 1.5 & 1.5 & 1.5 & 12 \\ 0 & 1.5 & 1.5 & 1.5 & 1.5 \\ 1.5 & 1.5 & 1.5 & 1.5 & 1.5 \\ 0 & 1.5 & 1.5 & 1.5 & 0\end{matrix} ] .$$

Then, the display device drives each of the backlight lamps according to the output power value Pout

$$[ \begin{matrix}0 & 1.5 & 1.5 & 1.5 & 12 \\ 0 & 1.5 & 1.5 & 1.5 & 1.5 \\ 1.5 & 1.5 & 1.5 & 1.5 & 1.5 \\ 0 & 1.5 & 1.5 & 1.5 & 0\end{matrix} ]$$

of each of the backlight lamps, and the contrast of the display device for displaying the video data is enhanced. In this embodiment, a person skilled in the art can easily discover that, the magnitude of increase in the output power value Pout of the backlight lamp having a higher input power value Pin (e.g., the backlight having a 8 W input power value) is larger (i.e., increased by 4 W); in contrast, the magnitude of increase in the output power value Pout of the backlight lamp having a smaller input power value Pin (e.g., the backlight having a 1 W input power value) is smaller (i.e., increased by 0.5 W). Therefore, the contrast of the display device is significantly enhanced.

That is to say, in this embodiment, by adjusting the input power value Pin of each of the backlight lamps, the rated power factor LBR and the predetermined power gain factor DR of each of the backlight lamps as well as the input power value Pin limited by the total power gain factor TPLR of the multiple backlight lamps are added on the basis of the input power value Pin of each of the backlight lamps, and the output power value Pout of each of the backlight lamps is acquired, such that the magnitude of increase in the output power value Pout corresponding to the backlight lamp having a higher input power input value Pin is larger than the magnitude of increase in the output power value Pout corresponding to the backlight lamp having a lower input power value Pin, thus enhancing the contrast of the display device. Further, it is ensured that the output power value Pout of each of the backlight lamps does not exceed the rated power value RP_{L}, and the sum of the output power values Pout of the multiple backlight lamps does not exceed the rated power value RP_{B} of the backlight source, thereby preventing burning of the backlight lamps and the backlight source.

Further, when acquiring the total power gain factor TPLR of the multiple backlight lamps above, the result of the associated equation is (160 W−23 W)/11.5 W=11.913. At this point, if the total power gain factor TPLR of the multiple backlight lamps is designated to be 11.913, the third additional power increment value A3 of each of the backlight lamps is

$$[ \begin{matrix}0 & 0.5 & 0.5 & 0.5 & 4 \\ 0 & 0.5 & 0.5 & 0.5 & 0.5 \\ 0.5 & 0.5 & 0.5 & 0.5 & 0.5 \\ 0 & 0.5 & 0.5 & 0.5 & 0\end{matrix} ] * 11.913 ,$$

and the third additional power increment value A3 corresponding to the backlight lamp having an input power value Pin of 8 W is 4 W*11.913=47.652 W, and the output power value Pout corresponding to the backlight lamp is 47.652 W+8 W=55.652 W, and the output power value Pout correspondingly outputted by the backlight is 47.652 W+8 W=55.562 W, which is far greater than the rated power value RP_{L} of 12 W of the backlight lamp. If the backlight lamp is driving by this output power value Pout, the backlight lamp would be burned. Thus, in an embodiment of the present invention, when the ratio of the difference of the rated power value RP_{B} of the backlight source subtracted by the total TPin of the input power value of the multiple backlight lamps to the total TA2 of the second additional power increment values of the multiple backlight lamps is greater than 1, the total power gain factor TPLR of the multiple backlight lamps is designated to be 1.

It should be noted that, the method for acquiring the output power value Pout of each of the backlight lamps through adjusting the input power value Pin of each of the backlight lamps is not limited to the method described above, and the other adjustment method may be used.

For example, in an application scenario, the rated power factor LBR of each of the backlight lamps in the display device is the ratio of the rated power value RP_{L} to the normal operating power limit value PL of each of the backlight lamps, i.e., LBR=RP_{L}/PL. Other associated parameters and acquisition method are consistent with those described in the foregoing method, and such details may be referred from the description of the foregoing embodiments and are omitted herein. At this point, the second additional power increment value A2 of each of the backlight lamps is the incremented value obtained from adjusting the input power value Pin of each of the backlight lamps according to the predetermined gain factor DR and the rated power factor LBR, and the third additional power increment value A3 acquired is a final power value including the input power value Pin. That is to say, the third additional power increment value A3 of each of the backlight lamps serves as the output power value Pout of each of the backlight lamps, i.e., Pout=A3. For example, assume that the rated power value RP_{B} of the backlight source is 160 W, the number N_{LED} of the backlight lamps in the backlight source is 20, and the rated power value RP_{L} of each of the backlight lamps is 12 W. Thus, the acquired input power value Pin corresponding to each of the backlight lamps according to the video data is:

$$[ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ]$$

in a unit of W, and the predetermined power gain factor DR is 1. It is concluded from the above information that, the normal operating power limit values PL of the backlight lamps are all 8 W, the additional power factor LBR of each of the backlight lamps is 12 W/8 W=1.5, the first additional power increment value A1 of each of the backlight lamps is

$$[ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ] * 1 = [ \begin{matrix}0 & 1 & 1 & 1 & 8 \\ 0 & 1 & 1 & 1 & 1 \\ 1 & 1 & 1 & 1 & 1 \\ 0 & 1 & 1 & 1 & 0\end{matrix} ] ,$$

the second additional power increment value A2 of each of the backlight lamps is

$$[ \begin{matrix}0 & 1 & 1 & 1 & 0 \\ 0 & 1 & 1 & 1 & 1 \\ 1 & 1 & 1 & 1 & 1 \\ 0 & 1 & 1 & 1 & 0\end{matrix} ] * 1.5 = [ \begin{matrix}0 & 15 & 1.5 & 1.5 & 12 \\ 0 & 1.5 & 1.5 & 1.5 & 1.5 \\ 1.5 & 1.5 & 1.5 & 1.5 & 1.5 \\ 0 & 1.5 & 1.5 & 1.5 & 0\end{matrix} ] ,$$

and the total TA2 of the second additional power increment values of the multiple backlight lamps is: 0+1.5+1.5+1.5+12+0+1.5+1.5+1.5+1.5+1.5+1.5+1.5+1.5+1.5+0+1.5+1.5+1.5+0=34.5 W. Meanwhile, the total TPin of the input power values of the multiple lamps is 23 W. Thus, the total power gain factor TPLR of the multiple backlight lamps corresponds to (160 W−23 W)/34.5 W=3.971. Because the 3.971>1, the total power gain factor TPLR of the multiple backlight lamps is 1, and so the third additional power increment value A3 of each of the backlight lamps is

$$[ \begin{matrix}0 & 15 & 1.5 & 1.5 & 12 \\ 0 & 1.5 & 1.5 & 1.5 & 1.5 \\ 1.5 & 1.5 & 1.5 & 1.5 & 1.5 \\ 0 & 1.5 & 1.5 & 1.5 & 0\end{matrix} ] * 1 = [ \begin{matrix}0 & 15 & 1.5 & 1.5 & 12 \\ 0 & 1.5 & 1.5 & 1.5 & 1.5 \\ 1.5 & 1.5 & 1.5 & 1.5 & 1.5 \\ 0 & 1.5 & 1.5 & 1.5 & 0\end{matrix} ] , i . e . ,$$

the third additional power increment value A3 is the output power value Pout corresponding to each of the backlight lamps, and the display device then drives each of the backlight lamps according to the corresponding output power value Pout

$$[ \begin{matrix}0 & 15 & 1.5 & 1.5 & 12 \\ 0 & 1.5 & 1.5 & 1.5 & 1.5 \\ 1.5 & 1.5 & 1.5 & 1.5 & 1.5 \\ 0 & 1.5 & 1.5 & 1.5 & 0\end{matrix} ]$$

of each of the backlight lamps. It is apparent that the output power value Pout of each backlight acquired through the method of this embodiment is similarly capable of enhancing the contrast of the display device, while also preventing burning of the backlight lamps and the backlight source.

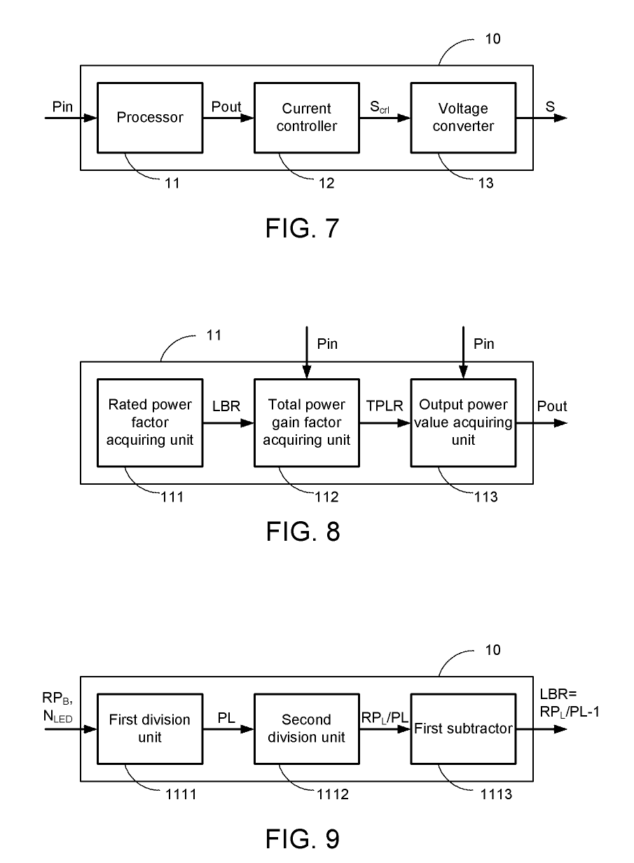

FIG. 7 shows a block diagram of a power control device for a backlight source of a display device according to an embodiment of the present invention. Referring to FIG. 7, the backlight source includes multiple backlight lamps arranged in an array and respectively corresponding to different display regions of the display device. In this embodiment, the display device in this embodiment may be an electronic apparatus having a display function, such as a television, a computer, a cell phone and a tablet computer, or a display device of the electronic apparatus. The power control device 10 includes a processor, a current controller 12 and a voltage converter 13.

The processor 11 is electrically connected to a main chip of the display device so as to acquire the input power value Pin that the main chip allocates to each of the backlight lamps according to the video data, and further adjusts the received input power value Pin of each of the backlight lamps to accordingly generate the output power value Pout of each of the backlight lamps. The adjustment magnitude in the output power value Pout acquired from the backlight lamp having a high input power value Pin is greater than the adjustment magnitude in the output power value Pout acquired from the backlight lamp having a low input power value Pin, the output power value Pout of each backlight lamp is not greater than the rated power value of the backlight lamp, and the total TPout of the output power values Pout of the multiple backlight lamps is not greater than the rated power value RP_{B} of the backlight source.

The current controller 12 is electrically connected to processor 11 to receive the output power value Pout of each of the backlight lamps after the adjustment of the processor 11, and accordingly generates a current control signal S_{crl} corresponding to each of the backlight lamps according to the output power value Pout of each of the backlight lamps.

The voltage converter 13 is electrically connected to the current controller 12 and each of the backlight lamps, and accordingly outputs a corresponding output current S to each of the backlight lamps according to the current control signal S_{crl} corresponding to each of the backlight lamps.

Implementation details of this embodiment can be referred from the description of the power control method for a backlight source of a display device of the foregoing embodiments, and are omitted herein.

In the method of this embodiment, the input power value Pin of the backlight source of the display device is adjusted by a power control device for a backlight source of a display device, such that the adjustment magnitude corresponding to the output power value Pout acquired from the backlight lamp having a high input power value Pin is greater than the output power value Pout acquired from the backlight lamp having a low input power value Pin, thus increasing the backlight brightness value of the display device for different display regions in a region-division manner and hence enhancing the contrast of the display device. Meanwhile, the output power value Pout of each of the backlight lamps is not greater than the rated power value RP_{L} of the backlight lamp, and the total output power value TPout of the multiple backlight lamps is not greater than the rated power value RP_{B} of the backlight source. As such, when the input power values Pin of the backlight lamps of the display device are adjusted, an issue of burning the backlight lamps or backlight source by overly high output power values Pout of the backlight lamps is avoided, while the rated power value RP_{B} of the backlight source does not need to be increased to further ensure that hardware costs are kept the same.

Referring to FIG. 8, in one embodiment, the processor 11 includes a rated power factor acquiring unit 111, a total power gain factor acquiring unit 112 and output power value acquiring unit 113.

The rated power factor acquiring unit 111 acquires the rated power factor LBR of each of the backlight lamps, so as to avoid the output power value Pout of each adjustment backlight lamp from exceeding the rated power value RP_{L} of the backlight lamp.

Referring to FIG. 9, the rated power factor acquiring unit 111 includes a first division unit 1111, a second division unit 1112 and a first subtractor 1113.

The first division unit 1111 acquires the ratio of the rated power value RBₚ of the backlight source to the number N_{LED} of backlight lamps in the backlight source to acquire the normal operating power limit value PL of each of the backlight lamps.

The second division unit 1112 acquires the ratio of the rated power value RP_{L} to the normal operating power limit value PL of each of the backlight lamps.

The first subtractor 1113 acquires the difference between the ratio of the rated power value RP_{L} to the normal operating power limit value PL of each of the backlight lamps and 1; at this point, the difference is used as the rated power factor LBR of each of the backlight lamps.

Further, the total power gain factor acquiring unit 112 acquires the total power gain factor TPLR of the multiple backlight lamps, so as to avoid the total TPout of the output power values Pout of the multiple backlight lamps from exceeding the rated power value RP_{B} of the backlight source.

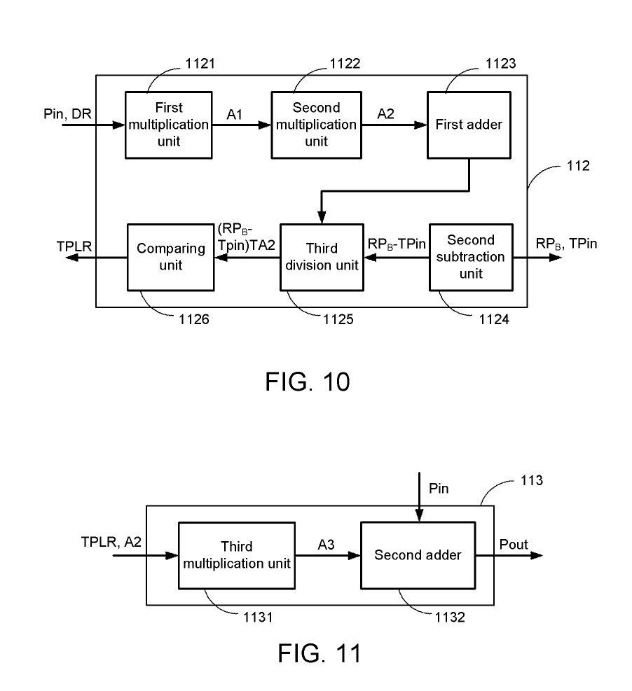

Specifically, referring to FIG. 10, the total power gain factor acquiring unit 112 includes a first multiplication unit 1121, a second multiplication unit 1122, a first adder 1123, a second subtraction unit 1124, a third division unit 1125 and a comparing unit 1126.

The first multiplication unit 1121 acquires a product of the input power value Pin and the predetermined power gain factor DR of each of the backlight lamps to acquire the first additional power increment value A1 of each of the backlight lamps.

The second multiplication unit 1122 acquires a product of the first additional power increment value A1 and the rated power factor LBR of each of the backlight lamps to acquire the second additional power increment value A2 of each of the backlight lamps.

The first adder 1123 acquires the total TA2 of the second additional power increment values of the multiple backlight lamps.

The second subtraction unit 1124 acquires a difference between the rated power value RP_{B} of the backlight source and the total input power value TPin of the multiple backlight lamps.

The third division unit 1125 acquires a ratio of the difference between the rated power value RP_{B} of the backlight source and the total TPin of the input power values of the multiple backlight lamps to the total TA2 of the second additional power increment values of the multiple backlight lamps.

The comparing unit 1126 compares whether the ratio of the difference of the rated power value RP_{B} of the backlight source subtracted by the total TPin of the input power values of the multiple backlight sources to the total TA2 of the second additional power increment values of the multiple backlight lamps is within the interval [0, 1]. When the ratio is within the interval [0, 1], the comparing unit 1126 outputs the ratio as the total power gain factor TPLR of the multiple backlight lamps; when the ratio is greater than 1, the comparing unit outputs 1 as the total power gain factor TPLR of the multiple backlight lamps.

The output power value Pout acquiring unit 113 acquires the output power value Pout of each of the backlight lamps according to the input power value Pin and the rated power factor LBR of each of the backlight lamps as well as the total power gain factor TPLR of the multiple backlight lamps.

Specifically, referring to FIG. 11, the output power value acquiring unit 113 includes a third multiplication unit 1131 and a second adder 1132.

The third multiplication unit 1131 acquires a product of the second additional power increment value A2 of each of the backlight lamps and the total power gain factor TPLR of the multiple backlight lamps to acquire the third additional power increment value A3 of each of the backlight lamps.

The second adder 1132 acquires a sum of the input power value Pin and the third additional power increment value A3 of each of the backlight lamps, and uses the sum as the output power value Pout of each of the backlight lamps.

Implementation details of this embodiment can be referred from the description associated with the power control method for a backlight source of a display device of the present invention, and such repeated details are omitted herein.

It should be noted that, the power control device of the backlight source of a display device of the present invention is not limited to the above implementation method.

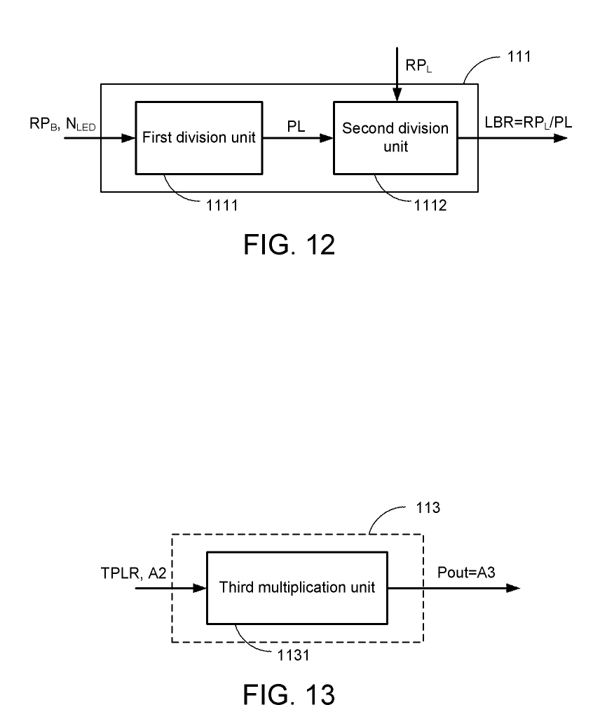

In another embodiment, referring to FIGS. 10, 12 and 13, the rated power factor acquiring unit 111 includes a first division unit 1111, a second division unit 1112; the total power gain factor acquiring unit 112 includes a first multiplication unit 1121, a second multiplication unit 1122, a first adder 1123, a second subtraction unit 1124, a second division unit 1125 and a comparing unit 1126; the output power value acquiring unit 113 includes a third multiplication unit 1131.

Functions and implementation details of the first division unit 1111, the first multiplication unit 1121, the second multiplication unit 1122, the first adder 1123, the second subtraction unit 1124, the third division unit 1125 and the comparing unit 1126 are identical to those in the previous embodiment, and are omitted herein.

It should be noted that, in this embodiment, the second division unit 1112 acquires a ratio of the rated power value RP_{L} to the normal operating power limit value PL of each of the backlight lamps, and uses the ratio as the rated power factor LBR of each of the backlight lamps. Further, the third multiplication unit 1131 acquires a product of the second additional power increment value A2 of each of the backlight lamps and the total power gain factor TPLR of the multiple backlight lamps so acquire the third additional power increment value A3 of each of the backlight lamps, and uses the third additional power increment value A3 of each of the backlight lamps as the output power value Pout of each of the backlight lamps.

Implementation details of the embodiment can be referred from the implementation method of the power control method for a backlight source of a display device of the present invention, and such repeated details are omitted herein.

In the above power control device for a backlight source of a display device, the output power value Pout of the backlight lamp is caused to be greater than the input power value Pin by using the predetermined power gain factor DR, and the magnitude of increase in the output power value Pout acquired from adjusting the backlight lamp having a higher input power value Pin is greater than the magnitude of increase in the output power value Pout acquired from adjusting the backlight lamp having a lower input value Pin, thus enhancing the contrast of the display device. Further, the additional power factor LBR adopted ensures that the backlight lamp is not burned due to the output power value Pout being greater than the rated power value RP_{L} of the backlight lamp, and at the same time avoids the total TPout of the output power values of the multiple backlight lamps from exceeding the rated power value RP_{B} of the backlight source and hence from burning the backlight source, thereby enhancing the display performance of the display device.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power control method for a backlight source of a display device, the backlight source comprising multiple backlight lamps arranged in an array respectively corresponding to different display regions of the display device, the power control method comprising:
acquiring an input power value corresponding to each of the backlight lamps according to video data;
adjusting the input power value of each of the backlight lamps to acquire an output power value of each of backlight lamps, wherein an adjustment magnitude in the output power value acquired from adjusting the backlight lamp having a high input power value is greater than an adjustment magnitude in the power output value acquired from adjusting the backlight lamp having a low input power value, the output power value of each of the backlight lamps is not greater than a rated power value thereof, and a total of the output power values of the multiple backlight lamps is not greater than a rated power value of the backlight source; and
driving each of the backlight lamps according to the corresponding output power value of each of the backlight lamps to enhance contrast of the display device.

2. The power control method according to claim 1, wherein the step of adjusting the input power value of each of the backlight lamps to acquire the output power value of each of backlight lamps further comprises:
acquiring a rated power factor of each of the backlight lamps to avoid the output power value of each of the backlight lamps from exceeding the rated power value thereof;
acquiring a total power gain factor of the multiple backlight lamps to avoid the total of the output power values of the multiple backlight lamps from exceeding the rated power value of the backlight source; and
acquiring the output power value of each of the backlight lamps according to the input power value and the rated power factor of each of the backlight lamps and the total power gain factor of the multiple backlight lamps.

3. The power control method according to claim 2, wherein the step of acquiring the rated power factor of each of the backlight lamps further comprises:
acquiring a normal operating power limit value of each of the backlight lamps according to the rated power value of the backlight source and the number of the backlight lamps in the backlight source; and
acquiring the rated power factor of each of the backlight lamps according to the rated power value and the normal operating power limit value of each of the backlight lamps.

4. The power control method according to claim 3, wherein the step of acquiring the total power gain factor of the multiple backlight lamps further comprises:
acquiring a first additional power increment value of each of the backlight lamps according to the input power and a predetermined power gain factor of each of the backlight lamps;
acquiring a second additional power increment value of each of the backlight lamps and a total of the second additional power increment values of the multiple backlight lamps according to the first additional power increment value and the rated power factor of each of the backlight lamps; and
acquiring the total power gain factor of the multiple backlight lamps according to the rated power value of the backlight source, the total of the input power values of the multiple backlight lamps, and the total of the second additional power increment values of the multiple backlight lamps.

5. The power control method according to claim 4, wherein when a ratio of a difference of the rated power value of the backlight source subtracted by the total of the input power values of the multiple backlight lamps to the total of the second additional power increment values of the multiple backlight lamps is within an interval [0, 1], the total power gain factor of the multiple backlight lamps is the ratio of the difference of the rated power value of the backlight source subtracted by the total of the input power values of the multiple backlight lamps to the total of the second additional power increment values of the multiple backlight lamps.

6. The power control method according to claim 4, wherein when the ratio of the difference of the rated power value of the backlight source subtracted by the total of the input power values of the multiple backlight lamps to the total of the second additional power increment values of the multiple backlight lamps is greater than 1, the total power gain factor of the multiple backlight lamps is 1.

7. The power control method according to claim 5, wherein the step of acquiring the output power value of each of the backlight lamps according to the input power value and the rated power factor of each of the backlight lamps and the total power gain factor of the multiple backlight lamps further comprises:
acquiring a third additional power increment value of each of the backlight lamps according to the second additional power increment value of each of the backlight lamps and the total power gain factor of the multiple backlight lamps; and
acquiring the output power value of each of the backlight lamps according to the third additional power increment value of each of the backlight lamps.

8. The power control method according to claim 7, wherein the rated power factor of each of the backlight lamps is a ratio of the rated power value to the normal operating power limit value of each of the backlight lamps subtracted by 1, and the output power value of each of the backlight lamps is a sum of the input power value and the third additional power increment value of each of the backlight lamps.

9. The power control method according to claim 7, wherein the rated power factor of each of the backlight lamps is a ratio of the rated power value to the normal operating power limit value of each of the backlight lamps, and the third additional power increment value of each of the backlight lamps serves as the output power value of each of the backlight lamps.

10. A power control device for a backlight source of a display device, the backlight source comprising multiple backlight lamps arranged in an array and respectively corresponding to different display regions of the display device, the power control device comprising:
a processor, electrically connected to a main chip of the display device to acquire an input power value that the main chip allocates to each of the backlight lamps according to video data, the processor further adjusting a received input power value of each of the backlight lamps to generate an output power value of each of the backlight lamps; wherein, an adjustment magnitude in the output power value acquired from adjusting the backlight lamp having a high input power value is greater than an adjustment magnitude in the power output value acquired from adjusting the backlight lamp having a low input power value, the output power value of each of the backlight lamps is not greater than a rated power value of the backlight lamp, and a total of the output power values of the multiple backlight lamps is not greater than a rated power value of the backlight source;
a current controller, electrically connected to the processor to receive the output power value of each of the backlight lamps to generate a current control signal corresponding to each of the backlight lamps according to the output power value of each of the backlight lamps; and
a voltage converter, electrically connected to the current controller and each of the backlight lamps, outputting a corresponding output current to each of the backlight lamps according to the current controller corresponding to each of the backlight lamps.

11. The power control device according to claim 10, wherein the processor further comprises:
a rated power factor acquiring unit, acquiring a rated power factor of each of the backlight lamps to avoid the output power value of each of the backlight lamps from exceeding a rated power value thereof;
a total power gain factor acquiring unit, acquiring a total power gain factor of each of the backlight lamps to avoid a total of the output power values of the multiple backlight lamps from exceeding the rated power value of the backlight source; and
an output power value acquiring unit, acquiring an output power value of each of the backlight lamps according to the input power value and the rated power factor of each of the backlight lamps and the total power gain factor of the multiple backlight lamps.

12. The power control device according to claim 11, wherein the rated power factor acquiring unit comprises:
a first division unit, acquiring a ratio of the rated power value of the backlight source to the number of backlight lamps in the backlight source to acquire a normal operating power limit value of each of the backlight lamps;
a second division unit, acquiring a ratio of the rated power value to the normal operating power limit value of each of the backlight lamps; and
a first subtractor, acquiring a difference between the ratio of the rated power value to the normal operating power limit value of each of the backlight lamps and 1, and utilizing the difference as the rated power factor of each of the backlight lamps.

13. The power control device according to claim 12, wherein the total power gain factor acquiring unit comprises:
a first multiplication unit, acquiring a product of the input power value and a predetermined power gain factor of each of the backlight lamps to acquire a first additional power increment value of each of the backlight lamps;
a second multiplication unit, acquiring a product of the first additional power increment value and the rated power factor of each of the backlight lamps to acquire a second additional power increment value of each of the backlight lamps;
a first adder, acquiring a total of the second additional power increment values of the multiple backlight lamps;
a second subtraction unit, acquiring a difference between the rated power value of the backlight source and a total of the input power values of the multiple backlight lamps;
a third division unit, acquiring a ratio of the difference between the rated power value of the backlight source and the total of the input power values of the multiple backlight lamps to the total of the second additional power increment values of the multiple backlight lamps; and
a comparing unit, comparing whether a ratio of a difference of the rated power value of the backlight source subtracted by the total of the input power values of the multiple backlight lamps to the total of the second additional power increment values of the multiple backlight lamps is within an interval [0, 1]; when the ratio of the difference of the rated power value of the backlight source subtracted by the total of the input power values of the multiple backlight lamps to the total of the second additional power increment values of the multiple backlight lamps is within an interval [0, 1], the comparing unit outputting the ratio of the difference of the rated power value of the backlight source subtracted by the total of the input power values of the multiple backlight lamps to the total of the second additional power increment values of the multiple backlight lamps as the total power gain factor of the multiple backlight lamps; when the ratio of the difference of the rated power value of the backlight source subtracted by the total of the input power values of the multiple backlight lamps to the total of the second additional power increment values of the multiple backlight lamps is greater than 1, the comparing unit outputting 1 as the total power gain factor of the multiple backlight lamps.

14. The power control device according to claim 13, wherein the output power value acquiring unit comprises:
a third multiplication unit, acquiring a third additional power increment value of each of the backlight lamps according to the second additional power increment value of each of the backlight lamps and the total power gain factor of the multiple backlight lamps; and
a second adder, acquiring a sum of the input power value and the third additional power increment value of each of the backlight lamps, and utilizing the sum as the output power value of each of the backlight lamps.

15. The power control device according to claim 11, wherein the rated power factor acquiring unit comprises:
a first division unit, acquiring a ratio of the rated power value of the backlight source to the number of the backlight lamps in the backlight source to acquire a normal operating power limit value of each of the backlight lamps; and
a second division unit, acquiring a ratio of the rated power value and the normal operating power limit value of each of the backlight lamps, and utilizing the ratio as the rated power factor of each of the backlight lamps.

16. The power control device according to claim 15, wherein the total power gain factor acquiring unit comprises:
a first multiplication unit, acquiring a product of the input power value and a predetermined power gain factor of each of the backlight lamps to acquire a first additional power increment value of each of the backlight lamps;
a second multiplication unit, acquiring a product of the first additional power increment value and the rated power factor of each of the backlight lamps to acquire a second additional power increment value of each of the backlight lamps;
a first adder, acquiring a total of the second additional power increment values of the multiple backlight lamps;
a second subtraction unit, acquiring a difference between the rated power value of the backlight source and a total of the input power values of the multiple backlight lamps;
a third division unit, acquiring a ratio of the difference between the rated power value of the backlight source and the total of the input power values of the multiple backlight lamps to the total of the second additional power increment values of the multiple backlight lamps; and
a comparing unit, comparing whether a ratio of a difference of the rated power value of the backlight source subtracted by the total of the input power values of the multiple backlight lamps to the total of the second additional power increment values of the multiple backlight lamps is within an interval [0, 1]; when the ratio of the difference of the rated power value of the backlight source subtracted by the total of the input power values of the multiple backlight lamps to the total of the second additional power increment values of the multiple backlight lamps is within an interval [0, 1], the comparing unit outputting the ratio of the difference of the rated power value of the backlight source subtracted by the total of the input power values of the multiple backlight lamps to the total of the second additional power increment values of the multiple backlight lamps as the total power gain factor of the multiple backlight lamps; when the ratio of the difference of the rated power value of the backlight source subtracted by the total of the input power values of the multiple backlight lamps to the total of the second additional power increment values of the multiple backlight lamps is greater than 1, the comparing unit outputting 1 as the total power gain factor of the multiple backlight lamps.

17. The power control device according to claim 16, wherein the output power value acquiring unit comprises:
a third multiplication unit, acquiring a product of the second additional power increment value of each of the backlight lamps and the total power gain factor of the multiple backlight lamps to acquire a third additional power increment value of each of the backlight lamps, and utilizing the third additional power increment value of each of the backlight lamps as the output power value of each of the backlight lamps.

18. The power control method according to claim 6, wherein the step of acquiring the output power value of each of the backlight lamps according to the input power value and the rated power factor of each of the backlight lamps and the total power gain factor of the multiple backlight lamps further comprises:
acquiring a third additional power increment value of each of the backlight lamps according to the second additional power increment value of each of the backlight lamps and the total power gain factor of the multiple backlight lamps; and
acquiring the output power value of each of the backlight lamps according to the third additional power increment value of each of the backlight lamps.
